(19) United States
(12) Patent Application Publication
(10) Pub. No.: US 2010/0030807 A1
(43) Pub. Date: Feb. 4, 2010

(54) LINKED AIRCRAFT RELIABILITY AND SOLUTION ANALYSIS SYSTEM AND METHOD

(75) Inventor: DAVID F. TOPPING, Seattle, WA (US)

Correspondence Address: TUNG & ASSOCIATES / RANDY W. TUNG, ESQ., 838 W. LONG LAKE ROAD, SUITE 120, BLOOMFIELD HILLS, MI, 48302, US

(73) Assignee: The Boeing Company

(21) Appl. No.: 12/183,035

(22) Filed: Jul. 30, 2008

(51) Int. Cl. G06F 17/30

(52) U.S. Cl. 707/104.1; 707/E17.044

(57) ABSTRACT

An automated linked aircraft reliability and solution analysis system includes a central database and an aircraft fleet reliability database comprising aircraft fleet reliability data and a service solutions database comprising service solution data connected to the central database. The central database is adapted to link the aircraft fleet reliability data in the aircraft fleet reliability database with the service solution data in the service solutions database. An automated linked aircraft reliability and solution analysis method is also disclosed.

### TECHNICAL FIELD OF THE INVENTION

The disclosure relates to analysis of aircraft and aircraft fleet reliability for the purpose of formulating solutions. More particularly, the disclosure relates to an automated linked aircraft reliability and solution analysis system and method in which aircraft and aircraft fleet reliability data is automatically integrated with aircraft solution information to indicate the applicable solutions or solutions in progress which are available to an aircraft operator to address reliability issues.

### BACKGROUND OF THE INVENTION

In the air travel industry, aircraft operators may periodically experience aircraft and aircraft fleet reliability issues such as schedule interruptions. In each case, the reliability issues may have various causes and may change quickly over time. Aircraft operators may solicit analysis and recommendations from aircraft manufacturers on solutions to the aircraft and aircraft fleet reliability issues.

Analysis and recommendations of aircraft manufacturers as to reliability issues based on an aircraft operator's specific reliability concerns may be a time-consuming process in which the quality of the analysis depends on data accuracy, data availability, time allowed for the analysis and expertise on personnel carrying out the analysis. The recommendations formulated by an aircraft manufacturer may change over time and by aircraft and fleet based on the aircraft fleet configuration, solutions which have already been incorporated to solve the issue, reliability of the fleet and available solutions provided by the aircraft manufacturer.

Currently, solutions to aircraft and aircraft fleet reliability issues may be formulated using detailed manual analysis by personnel who are familiar with the configurations of the aircraft or fleet under analysis with no specific criteria or defined methodology. Analysis for individual fleets and aircraft operators may require days or weeks to complete. A consistent or complete analysis cannot be guaranteed based on the vast knowledge required or the variations in fleet type, aircraft operator, reliability issues, economic data or available solutions.

Therefore, an automated linked aircraft reliability and solution analysis system and method is needed in which aircraft and aircraft fleet reliability data is automatically integrated with existing aircraft solution information and summarized to indicate the applicable solutions or solutions in progress which can be provided by an aircraft manufacturer to an aircraft operator to address reliability issues such as schedule interruptions.

### SUMMARY OF THE INVENTION

The disclosure is generally directed to a linked aircraft reliability and solution analysis system. An illustrative embodiment of the system includes a central database and an aircraft fleet reliability database comprising aircraft fleet reliability data and a service solutions database comprising service solution data connected to the central database. The central database is adapted to link the aircraft fleet reliability data in the aircraft fleet reliability database with the service solution data in the service solutions database.

The disclosure is further generally directed to a linked aircraft reliability and solution analysis method. An illustrative embodiment of the method includes providing aircraft fleet reliability data and service solution data pertaining to fleet reliability and performing a data analysis by linking the aircraft fleet reliability data with the service solution data.

### BRIEF DESCRIPTION OF THE ILLUSTRATIONS

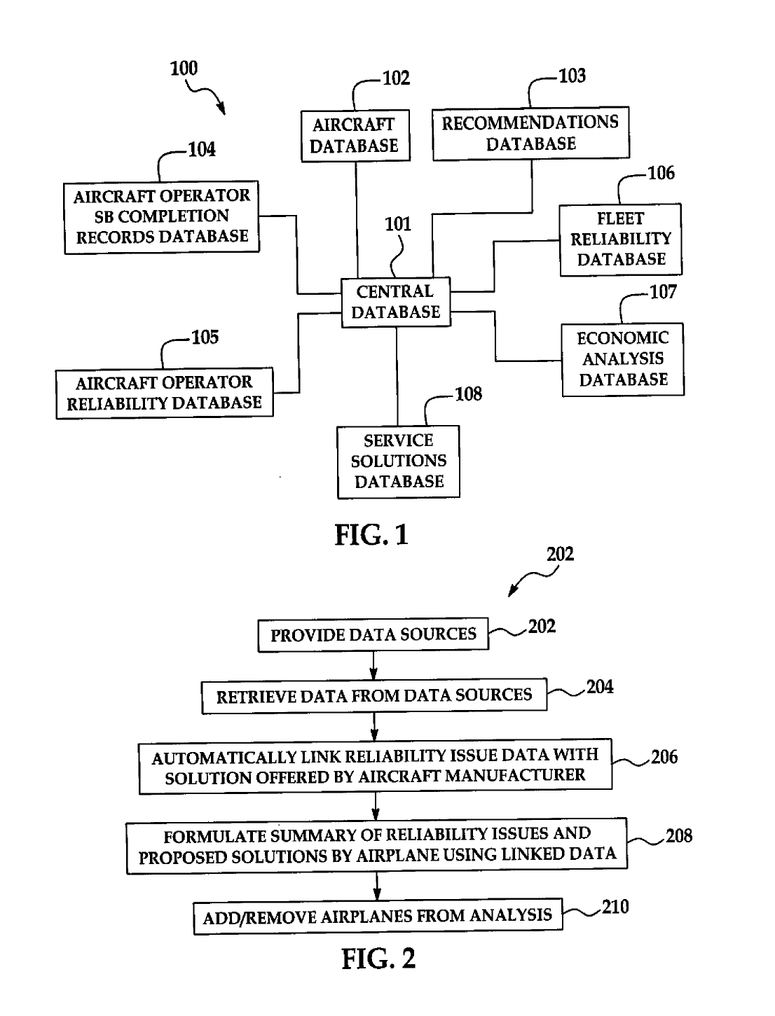

FIG. 1 is a schematic block diagram of an illustrative embodiment of the linked aircraft reliability and solution analysis system.

FIG. 2 is a flow diagram of an illustrative embodiment of the linked aircraft reliability and solution analysis method.

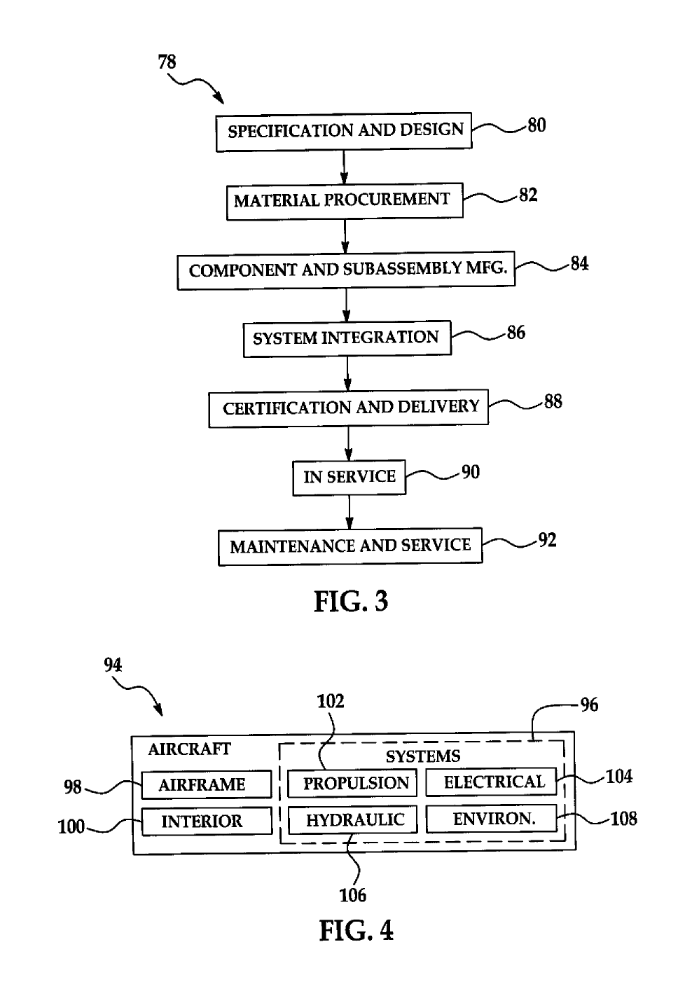

FIG. 3 is a flow diagram of an aircraft production and service methodology.

FIG. 4 is a block diagram of an aircraft.

### DETAILED DESCRIPTION OF THE PREFERRED EMBODIMENT

The disclosure is generally directed to a linked aircraft reliability and solution analysis system and method which automatically integrates aircraft and aircraft fleet reliability data with existing aircraft solution information and summarizes the applicable solutions or solutions in progress which an aircraft manufacturer is currently providing or may provide to an aircraft operator to address aircraft and aircraft fleet reliability issues such as schedule interruptions. The system and method may allow an operator to view all schedule interruptions for an aircraft fleet type over a specific time period as well as all applicable solutions or solutions-in-progress which the aircraft manufacturer is providing or may provide. The system and method may additionally assign a cost value to the schedule interruptions. In some embodiments, a selection may be made to analyze an entire fleet or subsets of a fleet including individual aircraft. The system and method may include formulation of a fleet summary which indicates the types and causes of delays experienced by each aircraft to indicate which of the aircraft in a fleet is the poorest behaving in several different areas. In some embodiments, the linked aircraft reliability and solution analysis system and method may be implemented using a web-based application.

Referring initially to FIG. 1, an illustrative embodiment of the linked aircraft reliability and solution analysis system, hereinafter system, is generally indicated by reference numeral 100. The system 100 may include a central database 101. The central database 101 may be adapted to extract data from various sources which will be hereinafter described and integrate, analyze and summarize the data to formulate effective solutions to aircraft and aircraft fleet reliability issues. The sources from which the central database 101 extracts data may include, for example and without limitation, an aircraft database 102; a recommendations database 103; an aircraft operator service bulletin completion records database 104; an aircraft operator reliability database 105; a fleet reliability database 106; an economic analysis database 107; and a service solutions database 108. Alternative or additional data sources may be utilized to maximize the accuracy of the analysis.

The aircraft data which is stored in the aircraft database 102 may include any and all data which is available for an aircraft or a fleet of aircraft that is supplied by an aircraft manufacturer. The aircraft data may include, for example and without limitation, aircraft delivery data; aircraft ownership data; aircraft configuration data; and aircraft tracking data. The service solution recommendation data which is stored in the recommendations database 103 may include any and all data which is compiled from service solution recommendations which a fleet team assembled by the aircraft manufacturer formulates for the resolution of aircraft and aircraft fleet reliability issues. The aircraft operator service bulletin data which is stored in the aircraft operator service bulletin completion records database 104 may include any and all data which is obtained from service bulletin completion records which pertain to a particular aircraft or aircraft fleet operated by an aircraft operator for the period of analysis in question. The data may be organized as an airplane-by-airplane list.

The aircraft operator reliability data which is stored in the aircraft operator reliability database 105 may include any and all data which pertains to an aircraft operator's reliability in operating an aircraft or aircraft fleet. This data may include, for example, flight delays having a duration which exceeds a predetermined time period (such as 15 minutes, for example); flight cancellations; diversions; and air turn backs, for example and without limitation. The fleet reliability data which is stored in the fleet reliability database 106 may include any and all data which pertains to reliability of an aircraft fleet which is operated by a particular aircraft operator. This data may include, for example and without limitation, flight delays having a duration which exceeds a predetermined time period (such as 15 minutes, for example); flight cancellations; diversions; and air turn backs, for example and without limitation. The fleet reliability data may additionally include aircraft age, hours and cycles, for example and without limitation.

The economic analysis data which is stored in the economic analysis database 107 may include any and all data which pertains to costs associated with aircraft and aircraft fleet reliability issues such as the economic impact or costs associated with schedule interruptions as estimated by the aircraft manufacturer or as reported by the aircraft operator, for example and without limitation. The service solutions data which is stored in the service solutions database 108 may include any and all data which pertains to applicable economic service bulletins, service letters, maintenance tips and fleet team digest articles, for example and without limitation, related to an aircraft or aircraft fleet.

In typical implementation, the system 100 may be set up as a web-based application for internet use by one or multiple aircraft operators to determine which solutions to aircraft and aircraft fleet reliability issues such as schedule interruptions are offered by an aircraft manufacturer. The aircraft data which is stored in the aircraft database 102, the recommendations data which is stored in the recommendations database 103 and the service solutions data which is stored in the service solutions database 108 may each be provided by the aircraft manufacturer. The aircraft operator service bulletin data which is stored in the aircraft operator service bulletin completion records database 104, the aircraft operator reliability data which is stored in the aircraft operator reliability database 105 and the fleet reliability data which is stored in the fleet reliability database 106 may be provided by each aircraft operator. The economic analysis data which is stored in the economic analysis database 107 may be provided by the aircraft manufacturer, the aircraft operator, or both. The central database 101 retrieves the data from each of the databases 102-108 and may perform a data analysis in which the data is automatically linked in such a manner that each reliability issue is listed with the available service solutions which are offered by the aircraft operator. The central database 101 may also present a summary of the reliability issues by airplane for the period under analysis. In some applications, the central database 101 may configured in such a manner that an aircraft operator can selectively add or remove reliability data of individual aircraft (which may be stored in the fleet reliability database 106) to and from the data analysis to better refine the solutions to reliability issues of a sub-fleet of aircraft or an individual aircraft. This may aid the aircraft operator in economical spending of a fleet improvement budget.

Referring next to FIG. 2, a flow diagram 200 of an illustrative embodiment of the linked aircraft reliability and solution analysis method is shown. In block 202, data sources are provided. The data sources may include, for example and without limitation, an aircraft database; a recommendations database; an aircraft operator service bulletin completion records database; an aircraft operator reliability database; a fleet reliability database; an economic analysis database; and a service solutions database. In block 204, data is retrieved from the data sources. For example and without limitation, aircraft data may be retrieved from the aircraft database; recommendations on improving aircraft reliability and aircraft fleet reliability may be retrieved from the recommendations database; aircraft operator service bulletin completion records may be retrieved from the aircraft operator service bulletin completion records database; aircraft operator reliability data may be retrieved from the aircraft operator reliability database; fleet reliability data may be retrieved from the fleet reliability database; economic analysis data may be retrieved from the economic analysis database; and service solutions data may be obtained from the service solutions database.

In block 206, a data analysis is performed in which reliability issue data is linked with solutions offered by an aircraft manufacturer. The links are created by associating using the Air Transport Association (ATA) codes. One may also use data mining to look for words (or part numbers or fault codes) in the pilot write-ups with the available solutions. One may also use known configuration information from the as-delivered or as-modified state to filer out solutions that do not apply. Additionally, one may use an In-Service Data Program, when applicable, to get higher fidelity solution linking. In block 208, a summary of reliability issues and proposed solutions by airplane or airplane fleet is formulated using the linked data obtained in block 206. In block 210, reliability data of individual aircraft may be selectively added to and removed from the analysis to better refine the solutions to reliability issues of a sub-fleet of aircraft or an individual aircraft.

Referring next to FIGS. 3 and 4, embodiments of the disclosure may be used in the context of an aircraft manufacturing and service method 78 as shown in FIG. 3 and an aircraft 94 as shown in FIG. 4. During pre-production, exemplary method 78 may include specification and design 80 of the aircraft 94 and material procurement 82. During production, component and subassembly manufacturing 84 and system integration 86 of the aircraft 94 takes place. Thereafter, the aircraft 94 may go through certification and delivery 88 in order to be placed in service 90. While in service by a customer, the aircraft 94 may be scheduled for routine maintenance and service 92 (which may also include modification, reconfiguration, refurbishment, and so on).

Each of the processes of method 78 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 4, the aircraft 94 produced by exemplary method 78 may include an airframe 98 with a plurality of systems 96 and an interior 100. Examples of high-level systems 96 include one or more of a propulsion system 102, an electrical system 104, a hydraulic system 106, and an environmental system 108. Any number of other systems may be included. Although an aerospace example is shown, the principles of the invention may be applied to other industries, such as the automotive industry.

The apparatus embodied herein may be employed during any one or more of the stages of the production and service method 78. For example, components or subassemblies corresponding to production process 84 may be fabricated or manufactured in a manner similar to components or subassemblies produced while the aircraft 94 is in service. Also, one or more apparatus embodiments may be utilized during the production stages 84 and 86, for example, by substantially expediting assembly of or reducing the cost of an aircraft 94. Similarly, one or more apparatus embodiments may be utilized while the aircraft 94 is in service, for example and without limitation, to maintenance and service 92.

Although the embodiments of this disclosure have been described with respect to certain exemplary embodiments, it is to be understood that the specific embodiments are for purposes of illustration and not limitation, as other variations will occur to those of skill in the art.

What is claimed is:

1. A linked aircraft reliability and solution analysis system, comprising:
a central database;
an aircraft fleet reliability database comprising aircraft fleet reliability data and a service solutions database comprising service solution data connected to said central database; and
wherein said central database is adapted to link said aircraft fleet reliability data in said aircraft fleet reliability database with said service solution data in said service solutions database.

2. The system of claim 1 wherein said central database is further adapted to summarize said aircraft fleet reliability data and said service solution data.

3. The system of claim 1 further comprising an aircraft database comprising aircraft data connected to said central database.

4. The system of claim 3 wherein said aircraft data comprises at least one of aircraft delivery data, aircraft ownership data, aircraft configuration data and aircraft tracking data.

5. The system of claim 1 further comprising a recommendations database comprising service solution recommendation data connected to said central database.

6. The system of claim 1 further comprising an aircraft operator service bulletin completion records database comprising aircraft operator service bulletin completion records data connected to said central database.

7. The system of claim 1 further comprising an aircraft operator reliability database comprising aircraft operator reliability data connected to said central database.

8. The system of claim 1 further comprising an economic analysis database comprising economic analysis data connected to said central database.

9. A linked aircraft reliability and solution analysis system, comprising:
a central database;
an aircraft fleet reliability database comprising aircraft fleet reliability data, a service solutions database comprising service solution data and a recommendations database comprising service solution recommendation data connected to said central database;
at least one of an aircraft database comprising aircraft data, an aircraft operator service bulletin completion records database comprising aircraft operator service bulletin completion records data, an aircraft operator reliability database comprising aircraft operator reliability data and an economic analysis database comprising economic analysis data connected to said central database; and
wherein said central database is adapted to link said aircraft fleet reliability data and at least one of said aircraft data, said aircraft operator service bulletin completion records data, said aircraft operator reliability data and said economic analysis data with said service solution data and said service solutions recommendation data.

10. The system of claim 9 wherein said central database is further adapted to summarize said aircraft fleet reliability data and at least one of said aircraft data, said aircraft operator service bulletin completion records data, said aircraft operator reliability data and said economic analysis data linked with said service solution data and said service solutions recommendation data.

11. The system of claim 9 wherein said aircraft data comprises at least one of aircraft delivery data, aircraft ownership data, aircraft configuration data and aircraft tracking data.

12. The system of claim 9 wherein said aircraft operator reliability data comprises at least one of flight delays having a duration which exceeds a predetermined time period, flight cancellations, diversions and air turn backs.

13. The system of claim 9 wherein said economic analysis data comprises costs associated with flight schedule interruptions as estimated by an aircraft manufacturer.

14. The system of claim 9 wherein said economic analysis data comprises costs associated with flight schedule interruptions as reported by an aircraft operator.

15. A linked aircraft reliability and solution analysis method, comprising:
providing aircraft fleet reliability data and service solution data pertaining to fleet reliability; and
performing a data analysis by linking said aircraft fleet reliability data with said service solution data.

16. The method of claim 15 further comprising summarizing said aircraft fleet reliability data and said service solution data.

17. The method of claim 15 further comprising adding reliability data of individual aircraft to said data analysis.

18. The method of claim 15 further comprising removing reliability data of individual aircraft from said data analysis.

19. The method of claim 15 further comprising adding economic analysis data to said data analysis and linking said economic analysis data with said service solution data.

20. The method of claim 15 further comprising adding at least one of aircraft data, aircraft operator service bulletin completion records data, aircraft operator reliability data and service solution recommendation data to said data analysis and linking said aircraft data, said aircraft operator service bulletin completion records data and said aircraft operator reliability data with said service solution recommendation data and said service solution data.

21. A linked aircraft reliability and solution analysis system, comprising:
a central database;
an aircraft database comprising aircraft data, an aircraft operator service bulletin completion records database comprising aircraft operator service bulletin completion records data, an aircraft operator reliability database comprising aircraft operator reliability data, an aircraft fleet reliability database comprising aircraft fleet reliability data, an economic analysis database comprising economic analysis data, a service solutions database comprising service solution data and a recommendations database comprising service solution recommendation data connected to said central database;
wherein said central database is adapted to perform a data analysis by linking said aircraft data, said aircraft operator service bulletin completion records data, said aircraft fleet reliability data, said aircraft operator reliability data and said economic analysis data with said service solution data and said service solutions recommendation data;
wherein said central database is adapted to summarize said data analysis;
wherein said central database is adapted to add reliability data of individual aircraft to said data analysis; and
wherein said central database is adapted to remove reliability data of individual aircraft from said analysis.

22. A linked aircraft reliability and solution analysis method, comprising:
providing a plurality of data sources;
retrieving aircraft data, aircraft operator service bulletin completion records data, aircraft operator reliability data, aircraft fleet reliability data, economic analysis data, service solution data pertaining to fleet reliability, and service solution recommendation data from said plurality of data sources;
performing a data analysis by linking said aircraft data, said aircraft operator service bulletin completion records data, said aircraft fleet reliability data, said aircraft operator reliability data and said economic analysis data with said service solution data and said service solutions recommendation data;
summarizing said data analysis;
adding reliability data of individual aircraft to said data analysis; and
removing reliability data of individual aircraft from said analysis.
